(19) United States
(12) Patent Application Publication
(10) Pub. No.: US 2007/0104200 A1
(43) Pub. Date: May 10, 2007

(54) NETWORK DEVICE WITH ROUTING FUNCTION AND POLICY ROUTE SETTING METHOD THEREOF

(75) Inventor: CHI-CHAO LAI, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,590

(22) Filed: Apr. 10, 2006

(30) Foreign Application Priority Data
Nov. 4, 2005 (TW) 94138772

(51) Int. Cl. H04L 12/56

(52) U.S. Cl. 370/392; 370/401

(57) ABSTRACT

A network device with routing function (10) includes a receiving module (100) for receiving packets, a routing module (140), a parsing module (120), and a policy route setting module (130). Each of the packets has a source IP address therein. The routing module includes a route table including a plurality of destination IP addresses. The parsing module is used for parsing the packets to retrieve source IP addresses therein, and for determining whether one of the destination IP addresses matches the source IP addresses to determine whether new policy routes are needed. The policy route setting module is used for setting the new policy routes including destination addresses matching the source addresses of the packets, and saving the new policy routes in the route table.

### FIELD OF THE INVENTION

The invention relates to network devices, and particularly to a network device with routing function and policy route setting method thereof.

### DESCRIPTION OF RELATED ART

A router is a special device for connecting two or more networks together, and for selecting different routes to send data packets according to Internet Protocol (IP) addresses therein. Each router employing the IP addresses for accessing networks has a route table. In the route table, each source IP address corresponds to a destination IP address, and a path from a source IP address to a corresponding destination IP address is a route. The router checks routes of the route table to determine how to send the data packets according to source and destination IP addresses therein.

Fixed routes are preset in the route table by users. If a network device with routing function receives data packets whose IP addresses are not in the route table, the network device sends the data packets according to a preset default route in the route table. Usually, the preset default route is a path to the Internet. If the network device with routing function receives data packets with destination IP addresses not in the route table, and the destination of the data packets is a network device of an internal network with variable IP addresses, such as a Voice over Internet Protocol (VoIP) device, the network device with routing function sends the data packets to the Internet, and then the data packets are sent back to the network device of the internal network. Thus, it is inefficient, and the data packets may be delayed or lost.

### SUMMARY OF INVENTION

An aspect of the invention provides a network device with routing function. The network device includes a receiving module for receiving packets, a routing module, a parsing module, and a policy route setting module. Each of the packets has a source Internet Protocol (IP) address therein. The routing module includes a route table including a plurality of destination IP addresses. The parsing module is used for parsing the received packets to retrieve source IP addresses therein, and for determining whether one of the destination IP addresses matches the source IP addresses of the received packets to determine whether new policy routes are needed. The policy route setting module is used for setting the new policy routes including destination addresses matching the source addresses of the packets, and for saving the new policy routes in the route table.

Another aspect of the invention provides a policy route setting method used in a network device with routing function. The network device includes a route table including a plurality of destination IP addresses. The policy route setting method includes steps of: receiving a packet; parsing the packet to retrieve a source IP address therein; determining whether there is a destination IP address in the route table matching the source IP address of the packet; and if there is no match, setting a new policy route including a destination address matching the source IP address of the packet, and saving the new policy route in the route table.

Other advantages and novel features will become more apparent from the following detailed description when taken in conjunction with the accompanying drawings, in which:

### BRIEF DESCRIPTION OF DRAWINGS

FIG. 1 is a schematic diagram of an application environment of a network device with routing function of an exemplary embodiment of the invention;

FIG. 2 is a block diagram of a network device with routing function of an exemplary embodiment of the invention; and

FIG. 3 is a flow chart of a policy route setting method of an exemplary embodiment of the invention.

### DETAILED DESCRIPTION

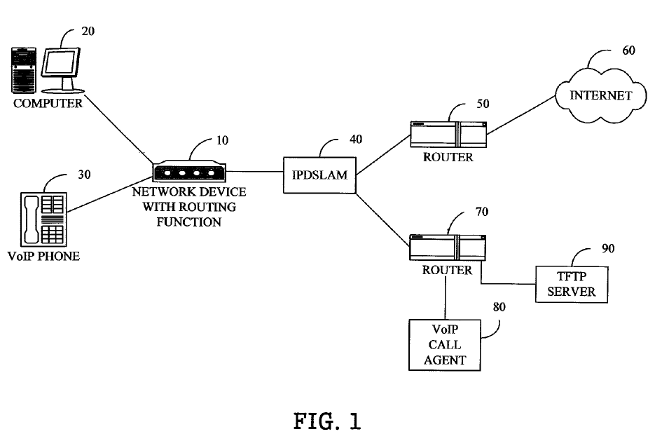

FIG. 1 is a schematic diagram of an application environment of a network device 10 with routing function of an exemplary embodiment of the invention. In the exemplary embodiment, the network device 10 may be a modem with routing function. The network device 10 is connected to a computer 20 and a Voice over Internet Protocol (VoIP) phone 30, and is connected to the Internet 60 via an Internet Protocol Digital Subscriber Line Access Multiplexer (IPDSLAM) 40 and a router 50, or connected to an internal network including a VoIP call agent 80 and/or a Trivial File Transfer Protocol (TFTP) server 90 via the IPDSLAM 40 and a router 70. The network device 10 transmits packets from the computer 20 or the VoIP phone 30 to the Internet 60 or an internal network.

The network device 10 includes a preset route table including a default route whose destination is the Internet 60. Because IP addresses of the VoIP call agent 80 and the TFTP server 90 change constantly, routes whose destinations are the VoIP call agent 80 or the TFTP server 90 are dynamically generated by the network device 10, and are also generated by the network device 10 when the network device 10 receives packets from the internal network. In the invention, the routes generated dynamically include policy routes.

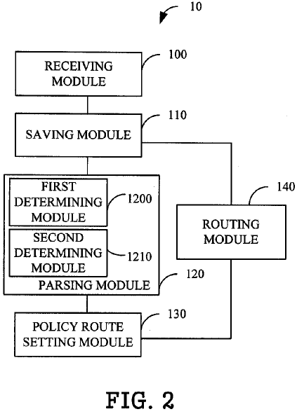

FIG. 2 is a block diagram of the network device 10 of an exemplary embodiment of the invention. In the exemplary embodiment, the network device 10 is used for transmitting packets, and includes a receiving module 100, a parsing module 120, a policy route setting module 130, and a routing module 140. The receiving module 100 is used for receiving packets. Each of the packets has a source IP address therein. In the exemplary embodiment, the packets include network packets from the Internet 60, the VoIP call agent 80, or the TFTP server 90. The routing module 140 includes a route table with multiple routes, and each route includes a destination IP address. In another exemplary embodiment, the routing module 140 is also used for transmitting packets according to the routes of the route table. The parsing module 120 is used for parsing the received packets to retrieve source IP addresses therein, and for determining whether there is a destination IP address in the route table matching the source IP addresses of the packets to determine whether new policy routes are needed. The policy route setting module 130 is used for setting new policy routes, and for saving the new policy routes in the route table. The new policy routes include destination IP addresses matching the source IP addresses of the packets. In another exemplary embodiment, the policy route setting module 130 is also used for deleting old policy routes.

When the receiving module 100 receives packets from the computer 20 or the VoIP phone 30, the network device 10 only transmits the received packets according to the route table. When the receiving module 100 receives a network packet, the parsing module 120 parses the network packet to retrieve a source IP address therein, and searches destination IP addresses in the route table of the routing module 140 to determine whether there is a destination IP address matching the source IP address of the network packet. If there is a match, no new policy route is needed. At this time, when the network device 10 receives response packets from the computer 20 or the VoIP phone 30, the routing module 140 transmits the received response packets according to existing routes of the route table. If there is not a match, then a new policy route is generated. At this time, when the network device 10 receives response packets from the computer 20 or the VoIP phone 30, the routing module 140 transmits the received response packets according to the new policy route.

When the parsing module 120 determines that a new policy route is needed, the policy route setting module 130 sets the new policy route including a destination IP address matching the source IP address of the received network packet. The policy route setting module 130 also deletes old policy routes to save space in the route table and increase search efficiency.

In other exemplary embodiments, the network device 10 also includes a saving module 110 for temporarily saving packets received by the receiving module 100.

The parsing module 120 includes a first determining module 1200. The first determining module 1200 is used for determining whether a destination IP address in the route table matches the source IP addresses of received network packets. If there is a match, no new policy route is needed. If there is not a match, then a new policy route is needed.

The parsing module 120 also includes a second determining module 1210 for determining whether the network device 10 receives network packets from the internal network. In the exemplary embodiment, the network device 10 includes a plurality of interfaces for receiving network packets from different networks, that is, network packets from the Internet 60 and from the internal network including the VoIP call agent 80 and the TFTP server 90 are received via different interfaces. An internal network interface is the interface receiving network packets from the internal network. The second determining module 1210 determines whether the network device 10 receives network packets from the internal network interface. In the exemplary embodiment, policy routes are only set for the VoIP call agent 80 and/or the TFTP server 90. If the second determining module 1210 determines that network packets are not received via the internal network interface, that is, the network packets are not received from the internal network, the second determining module 1210 determines that no new policy route is needed, and there is no need for the first determining module 1200 to determine if a new policy route is needed, therefore, processing time is reduced. If the second determining module 1210 determines that network packets are received via the internal network interface, then the first determining module 1200 determines whether a new policy route is needed.

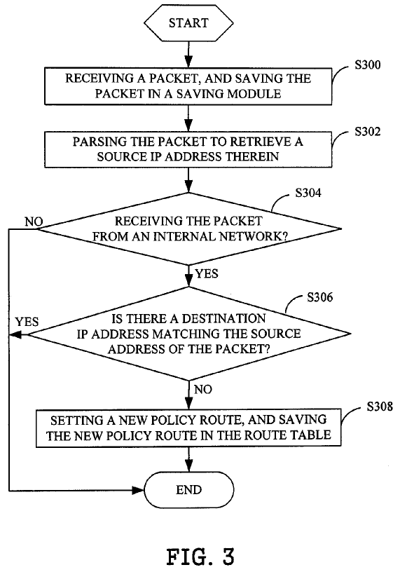

FIG. 3 is a flow chart of a policy route setting method of an exemplary embodiment of the invention. In step S300, the receiving module 100 receives a packet, and saves the packet in the saving module 110. The packet includes a network packet from the Internet 60, the VoIP call agent 80, or the TFTP server 90. In step S302, the parsing module 120 parses the packet to retrieve a source IP address therein. In step S304, the second determining module 1210 of the parsing module 120 determines whether the packet is received from the internal network. If the packet is not received from the internal network, the procedure finishes. If the packet is received from the internal network, in step S306, the first determining module 1200 determines whether there is a destination IP address in the route table matching the source IP address of the packet. If yes, the procedure finishes. If not, in step S308, the policy route setting module 130 sets a new policy route including a destination IP address matching the source IP address of the packet, saves the new policy route in the route table, and deletes old policy routes.

When the network device 10 receives network packets, the network device 10 determines whether new policy routes are needed, and can set new policy routes when needed. Thus, the network device 10 transmits packets efficiently. In addition, the network device 10 deletes old policy routes while setting new policy routes. Thus, use of space in the route table is reduced, and search efficiency is increased.

While embodiments and methods of the present invention have been described above, it should be understood that they have been presented by way of examples only and not by way of limitation. Thus the breadth and scope of the present invention should not be limited by the above-described exemplary embodiments, but should be defined only in accordance with the following claims and their equivalents.

What is claimed is:

1. A network device with routing function, comprising:
a receiving module, for receiving packets, wherein each of the packets has a source Internet Protocol (IP) address therein;
a routing module, comprising a route table, wherein the route table comprises a plurality of destination IP addresses;
a parsing module, for parsing the packets to retrieve the source IP addresses therein, and determining whether one of the plurality of destination IP addresses matches the source IP addresses to determine whether new policy routes are needed; and
a policy route setting module for setting the new policy routes comprising destination IP addresses matching the source IP addresses of the packets, and saving the new policy routes in the route table.

2. The network device as claimed in claim 1, further comprising a saving module for saving the packets.

3. The network device as claimed in claim 1, wherein the packets include network packets.

4. The network device as claimed in claim 3, wherein the parsing module comprises a first determining module for determining whether there is a destination IP address in the route table matching the source IP addresses of the network packets.

5. The network device as claimed in claim 4, wherein the parsing module further comprises a second determining module for determining whether the network packets are received from an internal network.

6. The network device as claimed in claim 1, wherein the policy route setting module is also used for deleting old policy routes in the route table.

7. The network device as claimed in claim 1, wherein the routing module is used for transmitting packets according to the route table.

8. The network device as claimed in claim 1, wherein the network device comprises a modem.

9. A policy route setting method for utilization in a network device with routing function, the network device comprising a route table comprising a plurality of destination IP addresses, comprising steps of:
receiving a packet;
parsing the packet to retrieve a source IP address therein;
determining whether there is a destination IP address in the route table matching the source IP address; and
setting a new policy route comprising a destination address matching the source IP address of the packet, and saving the new policy route in the route table if there is no destination IP address in the route table matching the source IP address.

10. The policy route setting method as claimed in claim 9, further comprising a step of saving the packet.

11. The policy route setting method as claimed in claim 9, wherein the step of determining whether there is a destination IP address in the route table matching the source IP address comprises a step of deleting old policy routes of the route table.

12. The policy route setting method as claimed in claim 9, wherein the packet comprises a network packet.

13. The policy route setting method as claimed in claim 12, further comprising a step of determining whether the packet is received from an internal network.
